(19) United States
(12) Patent Application Publication
(10) Pub. No.: US 2020/0122255 A1
(43) Pub. Date: Apr. 23, 2020

(54) ELECTROMACHINING SYSTEMS AND METHODS

(71) Applicant: General Electric Company, Schnectady, NY (US)

(72) Inventors: Yuanfeng Luo, Rexford, NY (US); Dong Liu, Shanghai (CN); Andrew Lee Trimmer, Niskayuna, NY (US); Steven Robert Hayashi, Niskayuna, NY (US)

(21) Appl. No.: 16/483,531

(22) PCT Filed: Feb. 8, 2017
(86) PCT No.: PCT/CN2017/073088

§ 371 Date: Aug. 5, 2019

(51) Int. Cl. B23H 7/12; B23H 1/04; B23H 1/10; B23H 7/22; B23H 9/10

(52) U.S. Cl. CPC B23H 7/12; B23H 1/04; B23H 9/10; B23H 7/22; B23H 1/10

(57) ABSTRACT

An electrode for use in an electromachining system includes a base and an outer rim extending circumferentially about the base. The electrode also includes a body extending between the base and the outer rim. The body defines a concave surface. The electrode is configured to discharge electrical arcs from the concave surface when electrical current is provided to the electrode.

### BACKGROUND

The field of the invention relates generally to rotary machines, and more particularly, to systems and methods for manufacturing components for rotary machines using electromachining processes.

At least some known rotary machines include a rotor shaft and at least one stage coupled to the rotor shaft. At least some known stages include a disk and circumferentially-spaced apart rotor blades that extend radially outward from the disk. Sometimes, the rotor blades are integrally manufactured with the disk as a one-piece component conventionally known as a blisk (i.e., bladed disk) or, more broadly, an integrally bladed rotor (IBR). At least some known blisks are machined from a single cylindrical billet of material. In at least some machining processes, the tool is moved repeatedly along and/or through portions of the billet to form slots in the billet. The time required to manufacture the blisks is at least partially determined by the rate at which the tool removes material from the billet. At least some known blisks have curved surfaces which are difficult to form using known tools and increase the time required to manufacture the blisks.

### BRIEF DESCRIPTION

In one aspect, an electrode for use in an electromachining system includes a base and an outer rim extending circumferentially about the base. The electrode also includes a body extending between the base and the outer rim. The body defines a concave surface. The electrode is configured to discharge electrical arcs from the concave surface when electrical current is provided to the electrode.

In another aspect, a system for use in an electromachining process includes an electrode configured for shaping a workpiece. The electrode includes a base, an outer rim extending circumferentially about the base, and a body extending between the base and the outer rim. The body defines a concave surface. The system also includes a translation apparatus coupled to the electrode. The translation apparatus is configured to move the electrode along an are having a first radius.

In another aspect, a method of manufacturing a blisk using an electromachining system includes moving an electrode along an arc. The electrode includes a base, an outer rim extending circumferentially about the base, and a body extending between the base and the outer rim. The body defines a concave surface. The method also includes supplying power to the electrode to induce electrical arcs between the electrode and the workpiece.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic view of an exemplary embodiment of an system for machining a workpiece;

FIG. 2 is a perspective view of an exemplary electrode for use with the system shown in FIG. 1;

FIG. 3 is a sectional view of the electrode shown in FIG. 2;

FIG. 4 is a top view of the electrode shown in FIGS. 2 and 3;

FIG. 5 is a perspective view of an alternative electrode for use with the system shown in FIG. 1 with a section of an outer rim removed; and

FIG. 6 is a flow diagram of an exemplary method of manufacturing a blisk using the system shown in FIG. 1.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations are combined and interchanged; such ranges are identified and include all the sub-ranges contained therein unless context or language indicates otherwise.

As used herein, the terms “processor” and “computer,” and related terms, e.g., “processing device,” “computing device,” and “controller” are not limited to just those integrated circuits referred to in the art as a computer, but broadly refers to a microcontroller, a microcomputer, a programmable logic controller (PLC), and application specific integrated circuit, and other programmable circuits, and these terms are used interchangeably herein. In the embodiments described herein, memory may include, but it not limited to, a computer-readable medium, such as a random access memory (RAM), a computer-readable non-volatile medium, such as a flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable, and include any computer program storage in memory for execution by personal computers, workstations, clients, and servers.

As used herein, the term “non-transitory computer-readable media” is intended to be representative of any tangible computer-based device implemented in any method of technology for short-term and long-term storage of information, such as, computer-readable instructions, data structures, program modules and sub-modules, or other data in any device. Therefore, the methods described herein may be encoded as executable instructions embodied in a tangible, non-transitory, computer-readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including without limitation, volatile and non-volatile media, and removable and non-removable media such as firmware, physical and virtual storage, CD-ROMS, DVDs, and any other digital source such as a network or the Internet, as well as yet to be developed digital means, with the sole exception being transitory, propagating signal.

Furthermore, as used herein, the term “real-time” refers to at least one of the time of occurrence of the associated events, the time of measurement and collection of predetermined data, the time to process the data, and the time of a system response to the events and the environment. In the embodiments described herein, these activities and events occur substantially instantaneously.

Embodiments of the present disclosure relate to systems and methods for manufacturing blade disks, i.e., blisks, using an electroerosion process. In particular, an electrode having a concave surface is used to shape a workpiece. The electrode is moved along an arc having a radius equal to a radius of the concave surface. Accordingly, the electrode provides greater surface area and removes material at an increased rate in comparison to other electrodes, such as rod-shaped electrodes. In addition, the electrode facilitates forming curved surfaces, such as airfoil surfaces, on the blisk.

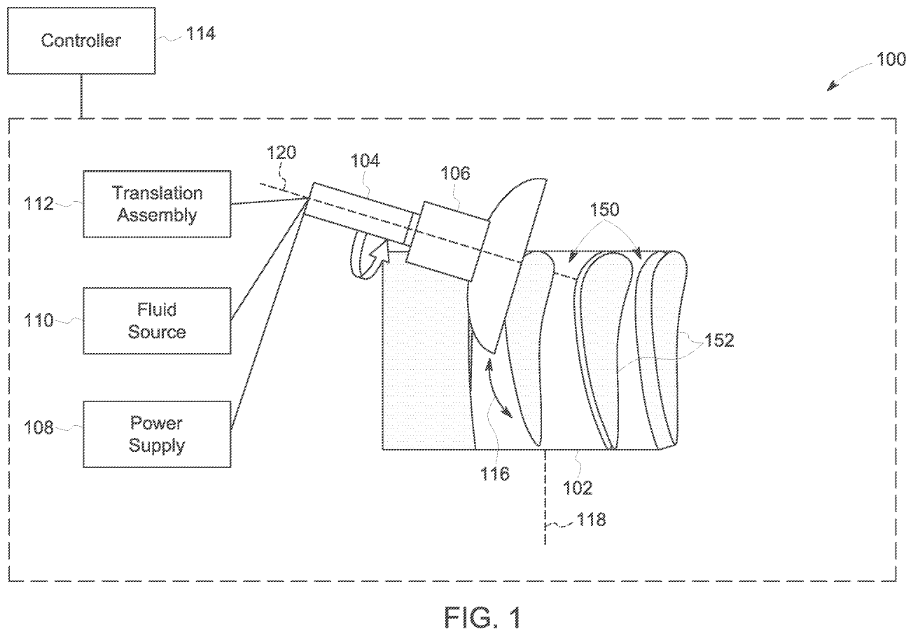

FIG. 1 is a schematic view of an exemplary embodiment of a system 100 for machining a workpiece 102. In the exemplary embodiment, system 100 is configured for electromachining workpiece 102 using an electroerosion process. In particular, system 100 forms a blisk from workpiece 102. In some embodiments, workpiece 102 includes a single cylindrical billet of material. In the exemplary embodiment, system 100 includes a tool head 104, an electrode or tool 106, a power supply 108, a fluid source 110, a translation apparatus 112, and a controller 114. In alternative embodiments, system 100 includes any component that enables system 100 to operate as described herein.

Also, in the exemplary embodiment, translation apparatus 112 is coupled to and configured to move electrode 106 relative to workpiece 102. In particular, translation apparatus 112 moves electrode 106 along an arc 116. Arc 116 extends substantially transverse relative to workpiece 102, i.e., electrode 106 performs a traverse-style machining of workpiece 102. In alternative embodiments, system 100 includes any translation apparatus 112 that enables system 100 to operate as described herein. For example, in some embodiments, electrode 106 moves in a substantially radial direction relative to an axis 118 of workpiece 102, i.e., electrode 106 performs a plunge-style machining of workpiece 102.

In addition, in the exemplary embodiment, tool head 104 is configured to support electrode 106. Electrode 106 and tool head 104 extend along a rotational axis 120 and are configured for electrode 106 to rotate about rotational axis 120. Tool head 104 is further configured to couple to translation apparatus 112 and facilitate electrode 106 moving in multiple directions. In alternative embodiments, system 100 includes any tool head 104 that enables system 100 to operate as described herein.

Moreover, in the exemplary embodiment, fluid source 110 is coupled to electrode 106 and is configured to provide fluid during operation of system 100. In particular, fluid source 110 includes a liquid such as, without limitation, water, de-ionized water, oil, a liquid containing an electrolyte, and combinations thereof. In alternative embodiments, system 100 includes any fluid source 110 that enables system 100 to operate as described herein.

Also, in the exemplary embodiment, power supply 108 is coupled to electrode 106 and workpiece 102 and configured to provide electrical current to at least one of electrode 106 and workpiece 102 to induce at least one electrical arc between electrode 106 and workpiece 102. As used herein, the terms “electrical arc” and “arcing” refer to a localized release of electrical energy. In the exemplary embodiment, power supply 108 is coupled to electrode 106 and workpiece 102 such that electrode 106 has a negative charge, i.e., forms a cathode, and workpiece 102 has a positive charge, i.e., forms an anode. In alternative embodiments, system 100 includes any power supply 108 that enables system 100 to operate as described herein.

In addition, in the exemplary embodiment, controller 114 regulates components of system 100 to control the machining of workpiece 102. For example, controller 114 regulates movement of electrode 106. In addition, controller 114 regulates power supply 108 to control electrical arcing between electrode 106 and workpiece 102. In some embodiments, controller 114 includes a computer numerical controlled (CNC) drive configured to regulate translation apparatus 112. In alternative embodiments, system 100 includes any controller that enables system 100 to operate as described herein.

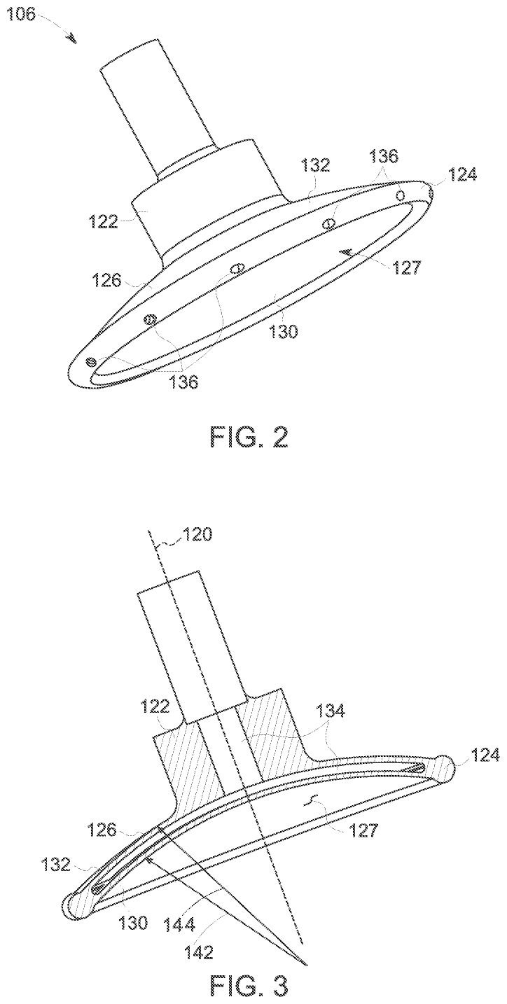

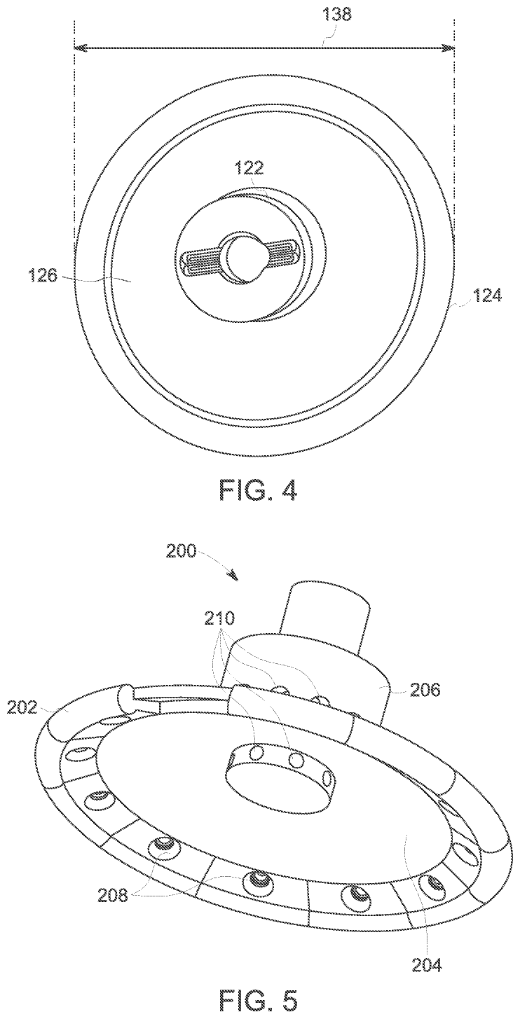

FIG. 2 is a perspective view of electrode 106 for use with system 100 (shown in FIG. 1). FIG. 3 is a sectional view of electrode 106. FIG. 4 is a top view of electrode 106. Electrode 106 includes a base 122, an outer rim 124, and a body 126. Base 122 is coupled to tool head 104 (shown in FIG. 1) such that electrode 106 rotates about rotational axis 120. Outer rim 124 extends circumferentially about base 122 and is spaced axially and radially relative to rotational axis 120. In alternative embodiments, electrode 106 is configured in any manner that enables system 100 (shown in FIG. 1) to operate as described herein.

In the exemplary embodiment, body 126 extends from base 122 to outer rim 124. Body 126 defines a first surface 130 and an opposite second surface 132. First surface 130 is circumscribed by outer rim 124. Second surface 132 is circumscribed by outer rim 124 and substantially surrounds base 122. Body 126 is substantially curved such that first surface 130 is concave and second surface 132 is convex. Accordingly, body 126 is substantially dome-shaped and defines a cavity 127. In alternative embodiments, electrode 106 includes any body 126 that enables electrode 106 to operate as described herein.

In addition, in the exemplary embodiment, outer rim 124 extends from first surface 130 to second surface 132. Outer rim 124 is curved from first surface 130 to second surface 132 to provide a smooth transition between first surface 130 and second surface 132. In addition, the curve of outer rim 124 from first surface 130 to second surface 132 has a relatively small radius in comparison to radiuses of first surface 130 and second surface 132. Accordingly, outer rim 124 provides a relatively small side edge profile that is configured to reduce unexpected discharges during operation of system 100 (shown in FIG. 1). In alternative embodiments, outer rim 124 has any shape that enables electrode 106 to operate as described herein.

Also, in the exemplary embodiment, electrode 106 defines channels 134 and openings 136 for fluid to flow therethrough. In particular, channels 134 are defined by base 122, body 126, and outer rim 124. Channels 134 are configured to direct fluid through electrode 106 to openings 136. For example, a first channel 134 extends through base 122, a second channel 134 extends through outer rim 124, and a third channel 134 extends between the first channel and the second channel. Channels 134 are in fluid communication with each other and with openings 136. Openings 136 are defined by outer rim 124 are configured to emit fluid during operation of system 100 (shown in FIG. 1). In particular, openings 136 are spaced circumferentially about outer rim 124 and configured to direct fluid between electrode 106 and workpiece 102 (shown in FIG. 1). In alternative embodiments, electrode 106 includes any channel and/or opening that enables system 100 (shown in FIG. 1) to operate as described herein. For example, in some embodiments, at least one opening 136 is defined by body 126 and/or base 122. In further embodiments, channels 134 and openings 136 are configured such that fluid flows across first surface 130 and/or second surface 132.

In addition, in the exemplary embodiment, outer rim 124 defines a diameter 138 of electrode 106. In some embodiments, diameter 138 is in a range of about 1 inch (2.5 centimeters) to about 30 inches (76 centimeters). In the exemplary embodiment, diameter 138 is about 5.6 inches (14 centimeters). In alternative embodiments, electrode 106 has any diameter that enables electrode 106 to operate as described herein.

Moreover, in the exemplary embodiment, electrode 106 has a depth 140 defined by body 126 and base 122. In some embodiments, depth 140 is in a range of about 0.25 inch (0.6 centimeters) to about 10 inches (25 centimeters). In the exemplary embodiment, depth 140 is about 1.8 inches (4.5 centimeters). In alternative embodiments, electrode 106 is any size that enables electrode 106 to operate as described herein.

Also, in the exemplary embodiment, first surface 130 has a radius 142 defining the concave shape of first surface 130. In some embodiments, radius 142 is in a range of about 0.1 inch (0.25 centimeters) to about 100 inches (250 centimeters). In further embodiments, radius 142 is in a range of about 1 inch (2.5 centimeters) to about 10 inches (25 centimeters). In the exemplary embodiment, radius 142 is about 6 inches (15.2 centimeters). In alternative embodiments, first surface 130 has any radius that enables electrode 106 to operate as described herein.

In addition, in the exemplary embodiment, second surface 132 has a radius 144 defining the convex shape of second surface 132. In some embodiments, radius 144 is in a range of about 0.1 inch (0.25 centimeters) to about 150 inches (381 centimeters). In further embodiments, radius 144 is in a range of about 1 inch (2.5 centimeters) to about 15 inches (38 centimeters). In the exemplary embodiment, radius 144 is about 6.25 inches (15.9 centimeters). In alternative embodiments, second surface 132 has any radius that enables electrode 106 to operate as described herein.

In the exemplary embodiment, electrode 106 is integrally formed from an electrically conductive material. In some embodiments, electrode 106 is formed from a material including, without limitation, graphite, metals such as brass/zinc, tellurium copper, copper tungsten, silver tungsten, and tungsten, and combinations thereof. For example, in some embodiments, electrode 106 is formed from a metallic powder with infiltrated graphite. In alternative embodiments, electrode 106 is formed from any material in any manner that enables system 100 (shown in FIG. 1) to operate as described herein. For example, in some embodiments, body 126 and outer rim 124 are formed separately and are coupled together.

In reference to FIGS. 1 and 3, during operation, translation apparatus 112 is configured to move electrode 106 relative to workpiece 102. In the exemplary embodiment, system 100 performs an electroerosion process which requires less force than at least some known machining processes such as mechanical based material removal processes. As a result, electrode 106 is able to have unique tool configurations that are not achievable with mechanical based material removal processes. In the exemplary embodiment, translation apparatus 112 induces electrode 106 to spin about rotation axis 120 and to move along arc 116. Arc 116 facilitates electrode 106 forming curved surfaces and reduces backgrinding during movement of electrode 106 relative to workpiece 102. In the exemplary embodiment, arc 116 has a radius substantially equal to radius 142. In alternative embodiments, translation apparatus 112 moves electrode 106 in any manner that enables system 100 to operate as described herein.

FIG. 5 is a perspective view of an alternative electrode 200 for use with system 100 (shown in FIG. 1) with a section of an outer rim 202 removed. Electrode 200 includes outer rim 202, a body 204, and a base 206. Outer rim 202 is removably coupled to body 204. Accordingly, outer rim 202 is removed and/or replaced when outer rim 202 experiences deterioration. In addition, outer rim 202 and body 204 are made of different materials, which reduces the cost to assemble electrode 200. In the exemplary embodiment, outer rim 202 includes a plurality of sections that couple to an edge of body 204. In alternative embodiments, electrode 200 includes any outer rim 202 that enables electrode 200 to operate as described herein.

In the exemplary embodiment, outer rim 202 defines circumferentially spaced openings 208. In particular, at least one opening 208 is defined in each section of outer rim 202. Base 206 defines openings 210. Openings 210 are positioned on opposite sides of body 204 such that fluid is directed across convex and concave surfaces of body 204. In alternative embodiments, electrode 200 includes any opening that enables electrode 200 to operate as described herein.

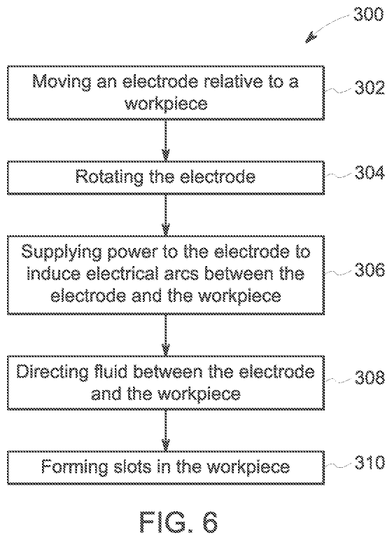

FIG. 6 is a flow diagram of an exemplary method 300 of manufacturing a blisk using system 100 (shown in FIG. 1). In reference to FIGS. 1 and 6, method 300 generally includes moving 302 electrode 106 relative to workpiece 102, rotating 304 electrode 106, supplying 306 power to electrode 106 to induce electrical arcs between electrode 106 and workpiece 102, directing 308 fluid between electrode 106 and workpiece 102, and forming 310 slots 150 in workpiece 102.

In some embodiments, electrical current is supplied to at least one of electrode 106 and workpiece 102 from power supply 108 to facilitate a high-speed electroerosion (HSEE) process. In particular, in the exemplary embodiment, controller 114 regulates power supply 108 to provide DC or pulsed waveforms to electrode 106 and induce multiple intermittent electrical arcs between electrode 106 and workpiece 102. The electrical arcing is spatially distributed over electrode 106 and configured to remove material from workpiece 102. In particular, the electrical arcs generate plasma that has a temperature higher than a melting point of workpiece 102. In addition, due to the shape of electrode 106, electrode 106 has an increased surface area available for the electrical arcing which increases the rate of material removal. Also, unexpected discharge is reduced because of the side profile shape of electrode 106. In alternative embodiments, electrical current is provided to electrode 106 and workpiece 102 in any manner that enables system 100 to operate as described herein. For example, in some embodiments, electrode 106 is the anode and workpiece 102 is the cathode.

In the exemplary embodiment, electrode 106 moves along a tool path precisely regulated by controller 114. For example, in some embodiments, electrode 106 is moved transversely through workpiece 102 in a transverse-style machining process. In further embodiments, electrode 106 is moved radially through workpiece 102 in a plunge-style machining process. In the exemplary embodiment, electrode 106 moves along arc 116. As electrode 106 moves relative to workpiece 102, electrical arcs between workpiece 102 and electrode 106 cause portions of workpiece 102 to erode and form slots 150. Slots 150 are machined to define blades 152 of the blisk. In some embodiments, blades 152 are substantially curved. Slots 150 are spaced circumferentially about axis 118 of workpiece 102. Accordingly, workpiece 102 is formed into a blisk having a plurality of blades 152 extending radially from a central member. The shape and curved movement of electrode 106 facilitate electrode 106 shaping the curved blades 152 and reduce the number of passes required to form slots 150. For example, the shape of electrode 106 allows electrode 106 to fit an airfoil shape without interference between electrode 106 and workpiece 102. In addition, the shape of electrode 106 facilitates electrode 106 machining a larger surface area of workpiece 102 in a reduced time in comparison to electrodes having other shapes, such as rods.

In some embodiments, directing 308 includes emitting fluid from openings 136 (shown in FIG. 2) in electrode 106. The fluid flows between electrode 106 and workpiece 102 to flush material removed from workpiece 102. Also, the fluid distributes heat during the electroerosion process and reduces heat affected zones of workpiece 102. In alternative embodiments, fluid is directed in any manner that enables system 100 to operate as described herein. For example, in some embodiments, a component distinct from electrode 106 is configured to provide the fluid between electrode 106 and workpiece 102.

In some embodiments, system 100 is used in an initial or rough machining step of manufacturing a blisk. In such embodiments, a finish machining step is carried out using any machining process, such as milling, electrical discharge machining (EDM), and electrochemical machining (ECM). In the exemplary embodiment, method 300 provides for an improved rough machining step because electrode 106 increases the accessibility of portions of workpiece 102 and reduces the amount stock material left on workpiece 102 for removal during finish machining. In some embodiments, the shape of electrode 106 is precisely designed to further reduce the amount of stock material and increase the rate of removal. For example, in some embodiments, the curve of the surfaces of electrode 106 has a radius that is determined to correspond to a specific surface formed in workpiece 102.

The embodiments described herein relate to systems and methods for manufacturing blade disks, i.e., blisks, using an electroerosion process. In particular, an electrode having a concave surface is used to shape a workpiece. The electrode is moved along an are having a radius equal to a radius of the concave surface. Accordingly, the electrode provides greater surface area and removes material at an increased rate in comparison to other electrodes, such as rod-shaped electrodes. In addition, the electrode facilitates forming curved surfaces, such as airfoil surfaces, on the blisk.

An exemplary technical effect of the assemblies and methods described herein includes at least one of: (a) reducing the time to manufacture blisks; (b) providing methods and systems for manufacturing a broader range of shapes of blisks; and (c) increasing the efficiency of electroerosion machining processes.

Exemplary embodiments of methods and systems are not limited to the specific embodiments described herein, but rather, components of systems and steps of the methods may be utilized independently and separately from other components and steps described herein. For example, the methods may also be used to manufacture other components, and are not limited to practice with only the components and methods as described herein. Rather, the exemplary embodiment can be implemented and utilized in connection with many other applications, equipment, and systems that may benefit from the advantages described herein.

Although specific features of various embodiments of the disclosure may be shown in some drawings and not in others, this is for convenience only. In accordance with the principles of the disclosure, any feature of a drawing may be referenced and claimed in combination with any feature of any other drawing.

Some embodiments involve the use of one or more electronic or computing devices. Such devices typically include a processor, processing device, or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are exemplary only, and thus are not intended to limit in any way the definition and/or meaning of the term processor and processing device.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An electrode for use in an electromachining system, said electrode comprising:
a base;
an outer rim extending circumferentially about said base; and
a body extending between said base and said outer rim, said body defining a concave surface, wherein said electrode is configured to discharge electrical arcs from said concave surface when electrical current is provided to said electrode.

2. The electrode in accordance with claim 1, wherein said base is configured to couple to a tool head such that said electrode is rotatable about a rotational axis.

3. The electrode in accordance with claim 1, wherein said concave surface has a second radius substantially equal to the first radius.

4. The electrode in accordance with claim 1, wherein said body defines a convex surface opposite said concave surface.

5. The electrode in accordance with claim 1, wherein at least one of said base, said outer rim, and said body define at least one opening configured to emit a fluid.

6. The electrode in accordance with claim 5, wherein said body defines a first channel in fluid communication with the at least one opening.

7. The electrode in accordance with claim 6, wherein said base defines a second channel in fluid communication with said first channel, said second channel configured to receive fluid from a fluid source.

8. The electrode in accordance with claim 1, wherein said body and said outer rim are integrally formed.

9. The electrode in accordance with claim 1, wherein said outer rim is removably coupled to said body.

10. A system for use in an electromachining process, said system comprising:
an electrode configured for shaping a workpiece, said electrode comprising:
a base;
an outer rim extending circumferentially about said base; and
a body extending between said base and said outer rim, wherein said body defines a concave surface; and
a translation apparatus coupled to said electrode, wherein said translation apparatus is configured to move said electrode along an arc having a first radius.

11. The system in accordance with claim 10 further comprising a tool head, wherein said base is coupled to said tool head such that said electrode is rotatable about a rotational axis.

12. The system in accordance with claim 10, wherein said concave surface has a second radius substantially equal to the first radius.

13. The system in accordance with claim 10, wherein said body defines a convex surface opposite the concave surface.

14. The system in accordance with claim 10 further comprising a fluid source configured to provide fluid to said electrode, wherein at least one of said base, said outer rim, and said body define at least one opening configured to emit the fluid.

15. The system in accordance with claim 10 further comprising a power supply coupled to said electrode, said power supply configured to induce electrical arcing between said electrode and the workpiece.

16. The system in accordance with claim 10 further comprising a controller coupled to said translation apparatus and said power supply, said controller configured to regulate movement of said tool and regulate electrical current supplied to said tool.

17. A method of manufacturing a blisk using an electromachining system, said method comprising:
moving an electrode along an arc, the electrode including a base, an outer rim extending circumferentially about the base, and a body extending between the base and the outer rim, wherein the body defines a concave surface; and
supplying power to the electrode to induce electrical arcs between the electrode and the workpiece.

18. The method in accordance with claim 17 wherein moving an electrode along an are comprises moving the electrode along an arc having a radius substantially equal to a radius of the concave surface.

19. The method in accordance with claim 15 further comprising directing fluid between the electrode and the workpiece, wherein the fluid is emitted from at least one opening in the electrode.

20. The method in accordance with claim 15 further comprising rotating the electrode about a rotational axis, wherein the electrode extends along the rotational axis.
